(19) United States
(12) Patent Application Publication
(10) Pub. No.: US 2017/0333993 A1
(43) Pub. Date: Nov. 23, 2017

(54) METHOD OF MAKING RARE EARTH PERMANENT MAGNET WITH EXCELLENT MAGNETIC PROPERTY

(71) Applicants: Hyundai Motor Company, Seoul (KR); Yantai Shougang Magnetic Materials Inc., Yantai City (CN)

(72) Inventors: Jae Ryung Lee, Hwaseong (KR); Zhongjie Peng, Yantai City (CN); Shengli Cui, Yantai City (CN); Zhanji Dong, Yantai City (CN); Yongcong Sun, Yantai City (CN); Hongjian Chen, Yantai City (CN)

(21) Appl. No.: 15/369,046

(22) Filed: Dec. 5, 2016

(30) Foreign Application Priority Data
May 23, 2016 (KR) 10-2016-0063012

(51) Int. Cl. B22F 3/26; B22F 3/16; H01F 1/057; B22F 9/04; C22C 38/06; C22C 38/00; C22C 35/00; C22C 33/04; H01F 41/02; C22C 38/16

(52) U.S. Cl. CPC B22F 3/26; H01F 41/0293; B22F 3/16; H01F 1/0577; H01F 1/0576; C22C 38/16; C22C 38/06; C22C 38/005; C22C 38/002; C22C 35/005; C22C 33/04; H01F 41/0266; B22F 9/04; B22F 2301/35; B22F 2202/05; B22F 2009/044; B22F 2304/10; B22F 2998/10

(57) ABSTRACT

Disclosed is a method of manufacturing a rare earth permanent magnet with substantially improved magnetic property. The method comprises: preparing a magnet master alloy by melting an R-T-B based alloy; pulverizing the magnet master alloy to provide a magnet powder; pressurizing the magnet powder as applying magnetic field to the magnet powder under an inert atmosphere to form a magnet molded body; sintering the magnet molded body under a vacuum atmosphere to obtain a sintered magnet molded body having oxygen content of about 0.1 wt % or less based on the total weight of the sintered magnet molded body; and treating the sintered magnet molded body with Dy and Tb.

### CROSS REFERENCE TO RELATED APPLICATION

The present application claims priority of Korean Patent Application No. 10-2016-0063012 filed on May 23, 2016, the entire contents of which is incorporated herein for all purposes by this reference.

### TECHNICAL FIELD

The present invention relates to a method of manufacturing a rare earth permanent magnet having substantially improved magnetic property. As such, the rare earth permanent magnet may be manufactured with increased thickness of orientation and dimension of the magnet and enhanced coercive force at the same time thereby mass production thereof may be facilitated.

### BACKGROUND OF THE INVENTION

In general, rare earth permanent magnets such as NdFeB-based permanent magnets have been used in various fields such household electric appliances or motors for vehicles, since these magnets have excellent magnetic properties and hence enable compact and high output motors to be made. In addition, as new industries have been developed and technology has been advanced, the rare earth permanent magnets have been extensively used in an electronic and communication field such as mobile phones and pick-up heads and a new energy field such as generators and motors for saving energy.

Further, due to such developments, a demand for high performance NdFeB-based permanent magnets has been increased, for example, magnetic properties are substantially improved even in extreme environments such as high temperatures such that those magnets can be used under various conditions.

Among magnetic properties of such NdFeB-based permanent magnets, one of them, i.e., residual magnetic flux density (Br) can be determined by a fraction of a main phase and density of NdFeB and a degree of magnetic orientation, and coercive force (HcJ) is related to microstructure of texture. In addition, refining of grain size or uniform distribution on the grain boundary phase may also influence to the coercive force (HcJ).

This can be expressed by the following Formula (I):

Residual magnetic flux density(Br)=A(1−β)(d/d0)cos θ.Jₛ Formula (I)

In the above formula, A means a volume of a positive area (%), 1−β means a volume of a main phase, Nd₂Fe₁₄B, d means a real density of a sintered magnet, d0 means a theoretical density of the sintered magnet, cos θ means a degree of orientation of grains, and Jₛ means a saturation magnetic polarization of mono crystals of a tetragonal Nd₂Fe₁₄B.

Coercive force(HcJ)=cHa−NeffMₛ Formula (II)

In Formula (II), c means a fine parameter, Ha means a anisotropic magnetic field energy, Neff means a demagnetization factor, and Mₛ means a saturated magnetic flux density.

In this case, Ha and Mₛ may have a direct effect on the intrinsic properties of NdFeB powder and c and Neff, in particular, are related to particle size, particle shape, and microstructure depending on distribution and amount of Nd-rich phase.

In general, since dysprosium-free and terbium-free NdFeB-based permanent magnets have a high residual magnetic flux density of 1.4 T but the coercive force thereof is very low as 960 kA/m, the temperature stability thereof is reduced and thus, their use may be very limited.

Accordingly, in order to enhance coercive force and operation temperature of the conventional NdFeB-based permanent magnets, various processes for increasing magnetic anisotropy energy by replacing the Neodymium (Nd) component with middle rare earth elements such as dysprosium (Dy), terbium (Tb) and the like have been proposed. However, there is still a demand for a process for making large sized permanent magnets, further enhancing magnetic flux density and coercive force, and enabling mass production of the permanent magnets.

As the foregoing described as the background art is just to promote better understanding of the background of the present invention, it must not be taken as an admission that it corresponds to the prior art well known to those who have ordinary skill in the art.

### SUMMARY OF THE INVENTION

In preferred aspects, the present invention may provide a method of manufacturing a rare earth permanent magnet having substantially improved magnetic properties, such that a large sized rare earth permanent magnet with excellent flux density and coercive force can be produced.

In one aspect, the present invention provides a method of manufacturing a rare earth permanent magnet having substantially improved magnetic property may include manufacturing an R-T-B based rare earth permanent magnet. In one exemplary embodiment, the method may comprise: preparing a master alloy from a R-T-B based alloy; pulverizing the master alloy to form a magnet powder; pressurizing the magnet powder as applying a magnetic field thereto to form a magnet molded body; sintering the magnet molded body under a reduced pressure to obtain a sintered magnet molded body having oxygen content of about 0.1 wt % or less based on the total weight of the sintered magnet molded body; and treating the sintered magnet molded body with dysprosium (Dy) and terbium (Tb).

The term “master alloy” as used herein refers to an intermediate alloy that can be used as a raw material for manufacturing a specific alloy composition. The master alloy typically includes a base metal component (e.g. as aluminum, copper, nickel or iron) and one or two other elements at higher percentage than the contents desired in the specific alloy composition. For example, the master alloy can be used adjusting composition with desired chemical and physical properties and/or controlling microstructure of the metal alloy during manufacturing process.

The term “R-T-B based alloy” or “R-T-B alloy” as used herein refers to an alloy material including one or more of rare earth elements (lanthanide; R), one or more of transition metal elements (T), and boron component (B). The R-T-B based alloy may be used as a raw material for producing a permanent magnet or a rare earth permanent magnet. wherein the rare earth elements (R) is one or more elements selected from among rare earth elements inclusive of yttrium(Y) and scandium(Sc), the transition metal elements (T) is one or more elements selected from iron(Fe) and cobalt(Co).

Preferably, the master alloy may be prepared from the molten R-T-B based alloy.

The magnet powder suitably may be pressurized under an inert atmosphere when the magnet molded body is formed.

The magnet molded body suitably may be sintered under a vacuum atmosphere when the sintered magnet molded body is obtained.

Preferably, the treating the sintered magnet molded body may comprise diffusing the dysprosium (Dy) and terbium (Tb), for example, into an interior of the sintered magnet molded body.

Preferably, the master alloy may be prepared by strip casting the R-T-B based alloy under a vacuum or inert atmosphere. The R-T-B based alloy suitably may comprise R (rare earth element) consisting of neodymium (Nd) or praseodymium (Pr), in an amount of about 25 to 30 wt %, boron (B) in an amount of about 0.3 to 2 wt %, and iron (Fe) constituting the remaining balance of the R-T-B based alloy, all the wt % based on the total weight of the R-T-B based alloy.

The R-T-B based alloy may comprise oxygen in an amount of about 0.1 wt % or less based on the total weight of the R-T-B based alloy and a transition metal comprising at least one selected from aluminum (Al), copper (Cu) and gallium (Ga).

The magnet powder may comprise lubricant coating layers formed on surfaces of the magnet powder by pulverizing the master alloy mixed with an amount of about 0.1 to 0.5 parts by weight of a lubricant with 100 parts by weight of the master alloy in a jet mill under an inert atmosphere.

Preferably, the master alloy may be pulverized by steps comprising: hydrogen or hydrogen-induced pulverizing the master alloy to form the magnet powder having a diameter of about 0.1 to 10 mm and nitrogen pulverizing the pulverized magnet powder to form the magnet powder having an average diameter of about 5.0 μm.

Preferably, the magnet molded body is sintered by heat treating the magnet molded body at a temperature of about 400 to 900° C. for about 1 to 10 hours and by baking the magnet molded body at a temperature of about 1000 to 1300° C. to provide the sintered magnet molded body.

The dysprosium (Dy) and terbium (Tb) may be used to treat the sintered magnet molded body. Preferably, the dysprosium (Dy) and terbium (Tb) may be diffused by immersing the sintered magnet powder molded body into a diffusive powder and then heat treating at a temperature of about 600 to 1000° C. under an inert atmosphere. The diffusive powder suitably may comprise the Dy and Tb in an amount of about 40 wt % or greater based on the total weight of the diffusive powder.

Preferably, the method of manufacturing the rare earth permanent magnet may further comprise, after the sintering the magnet molded body, cutting the sintered magnet molded body into a predetermined size and removing impurities on surfaces of the sintered magnet shaped body cut into the size is removed.

The present invention also provides a rare earth permanent magnet which may be obtainable from the method described herein.

Additionally, the present invention provides a rare earth permanent magnet which may be obtained from the method as described herein.

Further provided is a vehicle that may comprise the rare earth permanent magnet manufactured as described above.

Other aspects of the invention are disclosed infra.

According to various exemplary embodiments of the present invention, the rare earth permanent magnet may be manufacture in greater size with substantially improved magnetic properties such as magnetic flux density, coercive force and the like and thus manufactured rare earth permanent magnet can be used widely.

### BRIEF DESCRIPTION OF THE DRAWINGS

FIG. 1 shows an exemplary method of manufacturing a rare earth permanent magnet to provide substantially improved magnetic property according to an exemplary embodiment of the present invention.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Various exemplary embodiments of the present invention will now be described in detail with reference to the accompanying drawings. However, the present invention is not limited or restricted by the preferred embodiments. For reference, the same reference numerals refer to the substantially same component throughout this description. Under this rule, contents described with reference to other figures may be referred to in a certain description and contents that may be determined as being repeated or being evident to those who have ordinary skill in the art pertained to the present invention may be omitted.

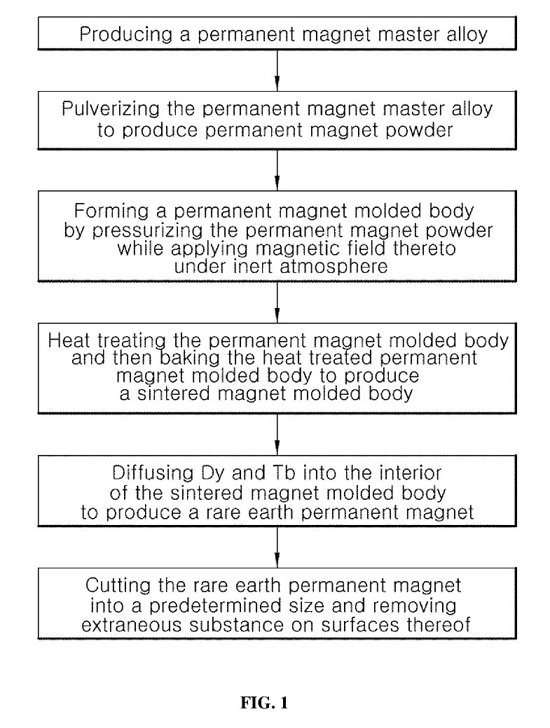

FIG. 1 shows an exemplary method of manufacturing an exemplary rare earth permanent magnet having substantially improved magnetic property according to an embodiment of the present invention.

As illustrated in FIG. 1, the method of the present invention may include manufacturing an R-T-B based rare earth permanent magnet in a dry manner. Preferably, the method may comprise: preparing a master alloy; pulverizing the master alloy into a magnet powder; pressurizing the magnet powder in magnetic field to form a magnet molded body; sintering the magnet molded body; and treating the sintered magnet molded body with a middle rare earth element(s) into an interior of the sintered magnet molded body.

In particular, during manufacturing the rare earth permanent magnet, oxygen content of the sintered magnet molded body may be controlled at the sintering and the oxygen content may be of about 0.1 wt % or less based on the total weight of the singer magnet molded body. As consequence, surface tension of the middle rare earth elements molten during the diffusion may increase thereby facilitating diffusion of the middle rare earth elements into the interior of the sintered magnet molded body.

Preferably, the rare earth element on the surface of a main phase particle may be replaced with a middle rare earth element(s) such that that residual magnetic flux density may be maintained at a constant level and coercive force may be enhanced greatly. Accordingly, a large sized permanent magnet can be produced and mass production of the permanent magnet can be obtained.

According to an exemplary embodiment of the present invention, the master alloy may be prepared from a molten R-T-B based alloy. The R-T-B based alloy includes “R” as of rare earth element, which may comprise neodymium (Nd) or praseodymium (Pr), “T” as of transition metal, which may comprise Fe or a mixture of Fe and cobalt, and “B” as of boron. The R-T-B based alloy may comprise neodymium (Nd) or praseodymium (Pr) in an amount of about 25 to 30 wt %, boron (B) in an amount of about 0.3 to 2 wt %, and Fe constituting the remaining balance of the R-T-B based alloy, all the wt % are based on the total weight of the R-T-B based alloy.

Preferably, the R-T-B based alloy may further comprise additional transition metal element including at least one selected from aluminum (Al), copper (Cu) and gallium (Ga), and oxygen (O).

In particular, the content of oxygen may be in an amount of 0.1 wt % or less based on the total weight of the R-T-B based alloy. When the oxygen content contained in the sintered magnet molded body prepared in the sintering step is minimized, diffusion of Dy and Tb in the subsequent diffusion step may be facilitated so that superior residual magnetic flux density may be obtained and coercive force may be enhanced, thereby enabling mass production of a large sized magnet.

When the R-T-B based alloy having the composition as described above is prepared, the master alloy may be obtained to suitably have a thickness of about 0.2 to 0.6 mm by melting and then strip casting the alloy.

When the master alloy is prepared, the master alloy may be pulverized to produce a magnet powder. Preferably, the pulverization step may comprise a first pulverization process, i.e., hydrogen pulverization or hydrogen-induced pulverization of the master alloy in a jet-mill manner and a second pulverization process, i.e., nitrogen pulverization of the pulverized master alloy using high pressure nitrogen gas after the first pulverization process.

In the first pulverization process, hydrogen pulverization of the permanent magnet master alloy may be carried out to produce magnet powder pulverized having a diameter of about 0.1 to 10 mm, while in the second pulverization process, nitrogen pulverization of the pulverized magnet powder may be carried out to produce the magnet powder having an average diameter of 5.0 μm.

Preferably, the master alloy may be mixed with lubricant and pulverized step when the magnet powder is formed. As such, lubricant coating layers may be formed on surfaces of the magnet powder produced in a jet mill, and the magnet powder may be prevented from contacting with oxygen in the atmosphere and thus prevented from being oxidized. As consequence, the oxygen content of the sintered magnet molded body may be maintained or limited to about 0.1 wt % or less based on the total weight of the sintered magnet molded body.

In addition, a grain boundary diffusion effect of Dy and Tb in the subsequent diffusion step may be improved, superior magnetic properties such as residual magnetic flux density and coercive force may be improved, and a large sized magnet may be produced in greater quantity.

According to one embodiment of the present invention, the lubricant may include, for example, zinc stearate, ethyl acetate, ethyl caproate, methyl ester, ethyl acrylate and the like. Without limiting to this, it is also possible to select the lubricant from various types of lubricants that may be coated on surfaces of the magnet powder to form a protective layer for preventing oxidation of the magnet powder.

Preferably, the lubricant in an amount of about 0.1 to 0.5 parts by weight may be added to the master alloy of 100 parts by weight. When the lubricant is added in an amount of less than about 0.1 parts by weight, the magnet powder may be in contact with oxygen in the atmosphere and oxidized, because the lubricant may not be sufficiently and uniformly coated on surfaces of the magnet powder having an average diameter of the 5 μm. When the lubricant is added in an amount of greater than about 0.5 parts by weight, quality of the magnet to be produced may be decreased because the lubricant may be over-coated and that time, and cost for manufacturing the magnet may increase because a separate removal step for removing the lubricant may be additionally needed.

After the magnet powder having lubricant coating layers formed on surfaces thereof as described above, the magnet powder may be subjected to isostatic pressing under the state and a magnetic field of about 1.5 to 3 T may be applied thereto to produce a magnet molded body having a molding density of about 4.0 to 4.3 g/cm³.

The produced magnet molded body may be sintered to produce a sintered magnet molded body under vacuum atmosphere (10⁻⁵ torr or less), by steps comprising heat treating and baking.

Preferably, the magnet molded body may be heat treated at a temperature of about 400 to 900° C. for about 1 to 10 hours. This heat treatment process may improve magnetic properties of the rare earth permanent magnet produced by diffusing middle rare earth elements such as Dy, Tb and the like in high purity and high content through the grain boundary of the sintered magnet molded body.

Further, the heat treatment process according to an embodiment of the present invention may be repeated or performed a plurality of times and may further comprise a quenching process for rapid cooling to room temperature after each heat treatment process.

Such a quenching process may promote production of grain boundary microstructure of the rare earth permanent magnet and thus further improve coercive force.

Thereafter, the magnet molded body heat treated in the sintering step may be baked at a temperature of about 1000 to 1300° C. to produce a sintered magnet molded body.

In the diffusion step, the sintered magnet molded body may be immersed into a diffusive powder and then heat treated at a temperature of about 600 to 1000° C. under inert atmosphere such that the middle rare earth elements may diffuse into the interior of the sintered magnet molded body, thereby producing a rare earth permanent magnet.

Preferably, the diffusive powder used in the present invention may comprise Dy and Tb in an amount of about 40 wt % or greater based on the total weight of the diffusive powder. When the content of Dy and Tb is less than about 40 wt %, Dy and Tb may not sufficiently diffuse into the interior of the sintered magnet molded body and quality of the rare earth permanent magnet may be deteriorated. Moreover, diffusion thereof may take longer thereby reducing productivity.

Preferably, the method of making the rare earth permanent magnet with substantially improved magnetic property according to an exemplary embodiment of the present invention may further comprise a surface treatment step, which may comprise steps of cutting the sintered magnet molded body into a predetermined standard size and impurities on the surfaces of the sintered magnet shaped bodies, and removing the cut impurities after the sintering step.

The impurities such as oxides formed on surfaces of the sintered magnet shaped bodies may be cut into the size after the middle rare earth elements are diffused into the grain boundary and removed. Additionally, the surface of the rare earth permanent magnet produced may be cleaned by means of at least one selected from alkali or acid agents.

Further, in the surface treating the sintered magnet molded body according to an exemplary embodiment of the present invention, surface treatment of the rare earth permanent magnet may be performed by means of a shot peening method after the impurities are removed as described above.

### EXAMPLE

Hereinafter, the present invention will be described in more detail with reference to specific inventive examples and comparative examples.

However, examples described below are preferred embodiments of the invention, but not intended to limit the scope of the present invention.

### (1) Example 1

Preparation step: An R-T-B based alloy comprising Pr: in an amount of 7 wt %, Nd in an amount of 23 wt %, B in an amount of 1 wt %, Al in an amount of 0.3 wt %, Cu in an amount of 0.1 wt %, and balance of Fe constituting the remaining balance of the R-T-B based alloy was subjected to strip casting under vacuum or inert atmosphere to prepare a master alloy, and then the permanent magnet master alloy was produced as an alloy sheet having thickness of 0.2 to 0.6 mm.

Pulverization stage: The master alloy prepared as above was pulverized to the grain size of 0.1 to 10 mm by means of hydrogen gas under inert atmosphere, and then further pulverized with zinc stearate of 0.1 wt % as lubricant by means of high pressure nitrogen in a jet mill manner to produce a magnet powder having an average diameter of 5.0 μm.

Forming step: The magnet powder was poured into a metal mold of inert atmosphere, and then was subjected to isostatic pressing at 200 MPa under the state that magnetic field of 2T is applied thereto, thereby producing a magnet molded body having a density of 4.0 to 4.3 g/cm².

Sintering step: The magnet molded body was heat treated at a temperature of 400 to 900° C. for 1 to 10 hours, and then was baked at a temperature of 1025° C., thereby producing a sintered magnet molded body having oxygen content of 0.04 wt %.

Surface treatment step: The sintered magnet molded body was cut into a standard size of 10 mm×10 mm×10 mm, oxides on surfaces of the sintered magnet shaped bodies cut into the size were removed, and then they are subjected to shot peening process.

Diffusion step: The sintered magnet molded bodies were disposed to be spaced at a certain distance and immersed into diffusive powder containing Dy and Tb in an amount of 40 wt % based on the total weight of the diffusive powder at a temperature of 850° C. for 10 hours to diffuse Dy and Tb into the interior of grain boundary.

### Comparative Example 1

The magnet powder was prepared in the same way as in example 1, except the magnet powder was prepared under atmosphere gas having oxygen concentration of 100 ppm. A sintered magnet molded body containing oxygen of 0.11 wt % was prepared in a sintering step.

### Comparative Example 2

A sintered magnet molded body containing oxygen of 0.04 wt % was prepared and a diffusion step was not performed.

### Comparative Example 3

A sintered magnet molded body containing oxygen of 0.11 wt was prepared and a diffusion step was not performed.

TABLE 1

| | | Oxygen | | | |
|---|---|---|---|---|---|
| | Size | concentration | Diffusion | Br | Hcj |
| | (mm) | (wt %) | step | (T) | (kA/m) |
| Example 1 | 10 × 10 × 10 | 0.04 | ∘ | 1.4 | 1621 |
| Comparative | 10 × 10 × 10 | 0.11 | ∘ | 1.39 | 1353 |
| Example 1 | | | | | |
| Comparative | 10 × 10 × 10 | 0.04 | x | 1.4 | 1115 |
| Example 2 | | | | | |
| Comparative | 10 × 10 × 10 | 0.11 | x | 1.39 | 1035 |
| Example 3 | | | | | |

In Table 1, coercive force and residual magnetic flux density of Example 1 according to an exemplary embodiment and Comparative Examples 1 are compared.

As shown in Table 1, it can be understood that when the diffusion step was carried out, coercive force was enhanced. Moreover, when oxygen concentration was sufficiently low and the same diffusion step is carried out, the coercive force was enhanced greatly.

### (2) Example 2

### Example 2

Preparation step: An R-T-B based alloy comprising Pr in an amount of 6 wt %, Nd in an amount of 24 wt %, B in an amount of 1 wt %, Al in an amount of 0.3 wt %, Cu in an amount of 0.1 wt %, and Fe constituting the remaining balance was prepared by strip casting under vacuum or inert atmosphere to prepare a magnet master alloy, and then the master alloy was produced as an alloy sheet having thickness of 0.2 to 0.6 mm.

Pulverization stage: The master alloy was pulverized to the grain size of 0.1 to 10 mm by means of hydrogen gas under inert atmosphere, and further pulverized with zinc stearate of 0.1 wt % as lubricant by means of high pressure nitrogen in a jet mill to produce a magnet powder having an average diameter of 5.0 μm.

Forming step: The magnet powder was poured into a metal mold of inert atmosphere, and then was subjected to isostatic pressing at 200 MPa under the state that magnetic field of 2 T was applied thereto, thereby producing a magnet molded body having a density of 4.0 to 4.3 g/cm³.

Sintering step: The magnet molded body was heat treated at a temperature of 400 to 900° C. for 1 to 10 hours, and then baked at a temperature of 1035° C., thereby producing a sintered magnet molded body having oxygen content of 0.09 wt %.

Surface treatment step: The sintered magnet molded body was cut into a standard size of 20 mm×20 mm×20 mm, oxides on surfaces of the sintered magnet shaped bodies cut into the size were removed, and then were subjected to shot peening process.

Diffusion step: The sintered magnet molded bodies were disposed to be spaced at a certain distance and immersed into diffusive powder containing Dy and Tb in an amount of 80 wt % based on the total weight of the diffusive powder at a temperature of 950° C. for 20 hours to diffuse Tb into the interior of grain boundary.

### Comparative Example 4

A sintered magnet molded body containing oxygen of 0.15 wt % was prepared, using a magnet master alloy having oxygen content of 0.2 wt %. Other processes are the same as those in example 2.

### Comparative Example 5

A sintered magnet molded body containing oxygen of 0.09 wt % was prepared without a diffusion step.

### Comparative Example 6

### A sintered magnet molded body containing oxygen of 0.15 wt % was prepared without a diffusion step.

TABLE 2

| | | Oxygen | | | |
|---|---|---|---|---|---|
| | Size | concentration | Diffusion | Br | Hcj |
| | (mm) | (wt %) | step | (T) | (kA/m) |
| Example 2 | 20 × 20 × 20 | 0.09 | ∘ | 1.355 | 1433 |
| Comparative | 20 × 20 × 20 | 0.15 | ∘ | 1.345 | 1195 |
| Example 4 | | | | | |
| Comparative | 20 × 20 × 20 | 0.09 | x | 1.355 | 1274 |
| Example 5 | | | | | |
| Comparative | 20 × 20 × 20 | 0.15 | x | 1.345 | 1195 |
| Example 6 | | | | | |

In Table 2, coercive force and residual magnetic flux density of Example 2 according to an exemplary embodiment and Comparative Examples 4-6 were compared.

As shown in Tables 1 and 2, it can be understood that as the size of the magnet was increased, coercive force was reduced sharply, as compared to Comparative Examples 1 to 6. On the contrary, as can be seen from the inventive examples 1 and 2, it can be understood that even if volume of the rare earth permanent magnet was increased by about 8 times, residual magnetic flux density was maintained at the equal level and coercive force can be maintained at 1,433 kA/m. Accordingly, it can be confirmed that the size of the magnet is increased, excellent residual magnetic flux density and coercive force can be secured.

### (3) Example 3

Preparation step: An R-T-B based alloy comprising Pr in an amount of 6 wt %, Nd in an amount of 24 wt %, B in an amount of 1 wt %, Al: 0.3 wt %, Cu in an amount of 0.1 wt %, and Fe constituting the remaining balance of the R-T-B based alloy was subjected to strip casting under vacuum or inert atmosphere to prepare a magnet master alloy, and then the magnet master alloy was produced as an alloy sheet having thickness of 0.2 to 0.6 mm.

Pulverization stage: The master alloy prepared as above was pulverized to the grain size of 0.1 to 10 mm by means of hydrogen gas under inert atmosphere, and further pulverized magnet master alloy with zinc stearate of 0.1 wt % as lubricant by means of high pressure nitrogen in a jet mill to produce a magnet powder having an average diameter of 5.0 μm.

Forming step: The magnet powder was poured into a metal mold of inert atmosphere, and then was subjected to isostatic pressing at 200 MPa under the state that magnetic field of 2T was applied thereto, thereby producing a magnet molded body having a density of 4.0 to 4.3 g/cm³.

Sintering step: The magnet molded body was heat treated at a temperature of 400 to 900° C. for 1 to 10 hours, and then is baked at a temperature of 1030° C., thereby producing a sintered magnet molded body having oxygen content of 0.03 wt %.

Surface treatment step: The sintered magnet molded body was cut into a standard size of 50 mm×50 mm×26 mm, oxides on surfaces of the sintered magnet shaped bodies cut into the size were removed, and then were subjected to shot peening process.

Diffusion step: The sintered magnet molded bodies were disposed to be spaced at a certain distance and immersed into diffusive powder containing Dy and Tb in an amount of about of 80 wt % based on the total weight of the diffusive powder at a temperature of 980° C. for 72 hours to diffuse Dy and Tb into the interior of grain boundary.

### Comparative Example 7

A sintered magnet molded body containing oxygen of 0.03 wt % was prepared in the same way as the example 3 except without a diffusion step.

TABLE 3

| | | Oxygen | | | |
|---|---|---|---|---|---|
| | Size | concentration | Diffusion | Br | Hcj |
| | (mm) | (wt %) | step | (T) | (kA/m) |
| Example 3 | 50 × 50 × 26 | 0.03 | ∘ | 1.355 | 1473 |
| Comparative | 50 × 50 × 26 | 0.03 | x | 1.355 | 1274 |
| Example 7 | | | | | |

As shown in Tables 1 to 3, it can be understood that at lower the oxygen content of the sintered magnet molded body immersed in the diffusive powder in the diffusion step, diffusion of Dy and Tb into the interior of the sintered magnet molded body was facilitated, thereby enhancing the coercive force.

As discussed above, according to various exemplary embodiments of the present invention, when the content of oxygen is maintained at an amount of about 1 wt % or less, diffusion of Dy and Tb in the subsequent diffusion step may be facilitated. Accordingly, even if size of the rare earth permanent magnet is increased, magnetic properties such as residual magnetic flux density, coercive force and the like may be maintained at a superior level.

Although the present invention has been described and illustrated with respect to specific embodiments, it will be apparent by those who have ordinary skill in the art that various modifications and changes to the present invention may be made without departing from the spirit and scope of the present invention as defined in the appended patent claims.

What is claimed is:

1. A method of manufacturing a rare earth permanent magnet, comprising:
preparing a master alloy from a molten R-T-B based alloy, wherein the rare earth elements (R) is one or more elements selected from among rare earth elements inclusive of yttrium(Y) and scandium(Sc), the transition metal elements (T) is one or more elements selected from iron(Fe) and cobalt(Co), B is boron(B); pulverizing the master alloy to form a magnet powder;
pressurizing the magnet powder as applying a magnetic field to the magnet powder to form a magnet molded body;
sintering the magnet molded body under a reduced pressure to obtain a sintered magnet molded body having oxygen content of about 0.1 wt % or less based on the total weight of the sintered magnet molded body; and
diffusing dysprosium (Dy) and terbium (Tb) into the interior of the sintered magnet molded body.

2. The method of claim 1, wherein the magnet powder is pressurized under an inert atmosphere to form the magnet molded body.

3. The method of claim 1, wherein the magnet molded body is sintered under a vacuum atmosphere to obtain the sintered magnet molded body.

4. The method of claim 1, wherein the magnet master alloy is prepared by strip casting the molten R-T-B based alloy under vacuum or inert atmosphere, and the R-T-B based alloy comprises a rare earth element comprising Nd or Pr in an amount of about 25 to 30 wt %, boron (B) in an amount of about 0.3 to 2 wt %, and iron (Fe) constituting the remaining balance of the R-T-B based alloy, all the wt % based on the total weight of the R-T-B based alloy.

5. The method of claim 4, wherein the R-T-B based alloy is an R-T-B-M-O based alloy, wherein O is oxygen, the transition metal elements (M) is one or more elements selected from iron(Fe) and cobalt(Co), B is boron(B).

6. The method of claim 1, wherein the magnet powder comprises lubricant coating layers formed on surfaces of the magnet powder by pulverizing the master alloy mixed with an amount of about 0.1 to 0.5 parts by weight of a lubricant with respect to 100 parts by weight of the master alloy under the inert atmosphere in a jet mill.

7. The method of claim 6, wherein the master alloy is pulverized by steps comprising: hydrogen pulverizing the master alloy to form the magnet powder having a diameter of about 0.1 to 10 mm and nitrogen pulverizing the pulverized magnet powder to provide the magnet powder having an average diameter of about 5.0 μm.

8. The method of claim 1, wherein the magnet molded body is sintered by heat treating the magnet molded body at a temperature of about 400 to 900° C. for about 1 to 10 hours and by baking the magnet molded body at a temperature of about 1000 to 1300° C. to provide the sintered magnet molded body.

9. The method of claim 1, wherein dysprosium (Dy) and terbium (Tb) are diffused by immersing the sintered magnet powder molded body into a diffusive powder and then by heat treating at a temperature of about 600 to 1000° C. under an inert atmosphere.

10. The method of claim 9, wherein the diffusive powder comprises Dy and Tb in an amount of about of 40 wt % or greater based on the total weight of the diffusive powder.

11. The method of claim 1, further comprising, after the sintering the magnet molded body, treating a surface of the sintered magnet molded body by cutting the sintered magnet molded body into a predetermined size and removing impurities on the surface of the sintered magnet molded body.
